(19) United States
(12) Patent Application Publication
(10) Pub. No.: US 2020/0094619 A1
(43) Pub. Date: Mar. 26, 2020

(54) Hub Bearing System

(71) Applicant: BOWMAN INTERNATIONAL LIMITED, Abingdon (GB)

(72) Inventor: Ian Breeze, Abingdon (GB)

(73) Assignee: BOWMAN INTERNATIONAL LIMITED, Abingdon (GB)

(21) Appl. No.: 16/142,254

(22) Filed: Sep. 26, 2018

(51) Int. Cl. B60B 27/00; F16C 17/02; F16C 33/08; F16C 43/02

(52) U.S. Cl. CPC B60B 27/0094; B60B 27/0078; F16C 17/02; F16C 33/08; F16C 43/02; B60Y 2200/22; F16C 2310/00; F16C 2326/02; B60B 2380/18; B60B 2380/80; B60B 2380/90; F16C 2226/60

(57) ABSTRACT

There is disclosed a hub bearing assembly having a housing having an internal cylindrical opening; an annular bearing accommodated within the cylindrical opening of the housing; and a cylindrical pin accommodated within the annular bearing, wherein the housing and the cylindrical pin rotate relative to each other.

### BACKGROUND TO THE INVENTION

### Field of the Invention

The invention relates to an improved design for a hub bearing system.

### Description of the Related Art

It is known in the art to provide free and fixed rolling element bearing assemblies. Typically these comprise a clamp ring assembly (bearing inner race and clamp collars), a cage and rolling element assembly, and a bearing outer race (fitted into a bearing housing), all of which is positioned in use around a shaft.

Such roller bearing assemblies may be incorporated in hubs. Example applications of such assemblies include, but are not limited to, automotive and truck transmissions, agricultural and construction equipment, pumps and compressors, and two-cycle engines such as marine outboards and garden equipment.

Traditional rolling element bearing assemblies used in hubs are associated with problems of dirt ingress and contamination.

In some areas of implementation hubs are replaced on a regular basis. For example when used with agricultural equipment, hubs incorporating rolling element bearings are typically replaced once a season.

An aim of the invention is to provide an improved hub bearing system.

### SUMMARY OF THE INVENTION

There is provided a replacement for traditional rolling element hub bearing assemblies which are more durable and hard wearing.

A seal free hub bearing system unit may be provided. Dirt and water can pass through the unit without causing damage.

Hubs can be replaced less frequently.

There is provided an improved hub bearing system which is seal free (i.e. non-lubricated). The improved hub bearing system utilises journal/plain/sliding bearings capable of supporting radial, axial and moment loads between two bodies rotating relative to each other about their shared axis of rotation.

The improved hub bearing system allows unidirectional or bidirectional relative rotation of a hub and a pin about their shared axis of relative rotation, whilst restricting relative rotation about the remaining two perpendicular axes. The improved hub bearing system also has to restrict bi-directional relative linear motion of the hub and the pin along all three perpendicular axes.

The journal/plain/sliding bearings are defined by two surfaces in motion relative to each other. There can be linear and/or rotational motion. Both surfaces are independent of each other at the bearing location, and it is the surfaces themselves that permit the relative motion.

Rolling element bearings are defined by two surfaces in motion relative to each other. There can be linear and/or rotational motion. Both surfaces are independent of each other at the bearing location, but the relative motion is permitted via the use of rolling elements, which are third entities in-between the two surfaces, enabling motion via rotation about their own rolling axis.

Loads are transmitted through elements rotating relative to each other—the hub bearing system is the system that avails the transfer of these forces across bodies rotating relative to each other.

Bearing components may be either fixed to the hub, fixed to the pin or neither fixed to hub or pin and merely enclosed within the system.

The external components may be fixed to either the hub or the pin, and both hub and pin may rotate relative to each other, and either may be stationary.

There is provided a hub bearing assembly comprising: a housing having an internal cylindrical opening; an annular bearing accommodated within the cylindrical opening of the housing; and a cylindrical pin accommodated within the annular bearing, wherein the housing and the cylindrical pin rotate relative to each other.

The internal cylindrical opening may be at least one void of revolution opening. The annular bearing may have a finite length. The annular bearing may be a solid of revolution. The cylindrical pin may be a solid of revolution.

The annular bearing may be fixed so that it rotates with the hub relative to the pin.

The annular bearing may be an integral part of the hub.

The annular bearing may be fixed so that it rotates with the pin relative to the hub.

The annular bearing may be an integral part of the pin.

The annular bearing may be accommodated between the housing and the cylindrical pin as an independent body.

The housing and the cylindrical pin rotate in the same direction or in opposite directions.

The hub bearing assembly may be configured to minimise relative rotation between the housing and the cylindrical pin about the two axes perpendicular to their common axis of rotation.

The annular bearing may have a finite length in the direction of the common axis of rotation.

The hub bearing assembly may be configured to minimise relative linear motion of the housing and the cylindrical pin along the common axis of rotation.

The hub bearing assembly may be configured to minimise relative linear motion of the housing and the cylindrical pin along the two axes perpendicular to their common axis of rotation.

The hub bearing assembly may be configured to minimise the linear motion of the housing and the cylindrical pin along the two axes perpendicular to their common axis of rotation bidirectionally and minimise the linear motion of the housing and the cylindrical pin along the common axis of rotation unidirectionally.

The relative linear motion along any of the common axis of rotation or the two axes perpendicular thereto is minimised by providing a bearing surface which is non-parallel to the shared axis of rotation.

The hub bearing assembly may further comprise a thrust element located adjacent the cylindrical pin, and having a thrust face towards the cylindrical pin.

The thrust element may be a washer.

The hub bearing assembly may further comprise a groove within the inner surface of the cylindrical opening, wherein the thrust washer is accommodated within the groove.

The hub bearing assembly may further comprise a first disc positioned between a first surface at the first end of the cylindrical steel pin and a surface of the thrust washer.

The hub bearing assembly may further comprise a second disc positioned at the other surface of the thrust washer.

The thrust element may be one of: fixed so it rotates with the housing relative to the cylindrical pin; fixed so it rotates with the cylindrical pin relative to the housing; accommodated between the housing and cylindrical pin relative rotating surfaces.

The annular bearing may comprise: a first annular bearing part between a first part of the cylindrical pin and the internal cylindrical opening of the housing; and a second annular bearing part between a second part of the cylindrical pin and the internal cylindrical opening of the housing.

The first annular bearing part may restrict linear motion along the common axis of rotation in a first direction, and the second annular bearing part restricts linear motion along the common axis of rotation in a second direction, the first direction being opposite to the second direction.

The bearing element may further comprise a pin extending from a position in the cylindrical.

The bearing element may further comprise a bolt for securing the second disc, the thrust washer and the first disc to the cylindrical steel pin.

The pin and thrust washer may rotate relative to the housing.

The housing may be fixed in position, and the pin and thrust washer rotate.

The housing may be fixed to a supporting frame.

The cylindrical steel pin may be connected to a rotatable element.

A second end of the cylindrical steel pin may be provided with a screw thread which is fitted to the rotatable element.

There is provided agricultural machinery comprising: a supporting frame; a housing comprising a cylindrical opening, the housing being fixably attached to the supporting frame; an annular bearing fitted to the cylindrical opening within the housing; and a cylindrical steel pin accommodated within the annular bearing, and having one end fixably attached to a rotating element.

The agricultural machinery may further comprise a thrust washer accommodated with the annular bearing, fixably attached to an other end the cylindrical steel pin.

There is provided a bearing element comprising: a housing comprising a cylindrical opening and having an annular groove within the cylindrical opening; an annular bearing fitted to the cylindrical opening; a cylindrical steel pin accommodated within the annular bearing; and a thrust washer accommodated within the annular groove.

The bearing element may further comprise a first disc positioned between a first surface at the first end of the cylindrical steel pin and a surface of the thrust washer.

The bearing element may further comprise a second disc positioned at the other surface of the thrust washer.

The bearing element may further comprise a pin extending from a position in the cylindrical steel pin and through the first disc, the thrust washer and the second pin. The bearing element may further comprise a bolt for securing the second disc, the thrust washer and the first disc to the cylindrical steel pin.

The pin and thrust washer may rotate relative to the housing.

The housing may be fixed in position, and the pin and thrust washer may rotate.

The housing may be fixed to a supporting frame.

The cylindrical steel pin may be connected to a rotatable element.

A second end of the cylindrical steel pin may be provided with a screw thread which is fitted to the rotatable element.

There is provided agricultural machinery comprising: a supporting frame; a housing comprising a cylindrical opening, the housing being fixably attached to the supporting frame; an annular bearing fitted to the cylindrical opening within the housing; a cylindrical steel pin accommodated within the annular bearing, and having one end fixably attached to a rotating element; and a thrust washer accommodated with the annular bearing, fixably attached to another end the cylindrical steel pin.

There is provided a fixed rolling element bearing assembly comprising: a housing; an inner race for attaching to a rotating shaft; a cage and rolling element assembly positioned around the inner race; first and second positional locators for positioning the cage and rolling element assembly between inner edges thereof; a thrust washer adjacent an outer edge of either the first or second positional locator and fixably connected to the housing.

There is provided a hub bearing system comprising: a hub (housing) containing (at least one) void of revolution opening within its body; at least one solid of revolution bearing (with finite length) accommodated within the (at least one) void of revolution opening(s) of the hub; and a solid of revolution pin accommodated within the (at least one) solid of revolution bearing(s).

A solid of revolution bearing can be one of: (i) held so that it rotates with the hub relative to the pin (or even an integral part of the hub); (ii) held so that it rotates with the pin relative to the hub (or even an integral part of the pin); or (iii) merely accommodated in-between both hub and pin relative rotating surfaces as an independent body.

Voids of revolution and solids of revolution are respectively voids and solids created by rotating about the shared axis of rotation of both hub and pin.

Both hub and pin are designed to relatively rotate about their shared axis of rotation.

The bearing surfaces of hub and pin may be arranged such that they restrict bidirectional relative rotation of the hub and the pin about the remaining two axes as well as restricting bidirectional relative linear motion of the hub and pin along all three axes.

This is achieved via bearing surface(s) created between hub and body that are non-parallel to the hub and pin shared axis of rotation, capable of restricting the motions listed.

The bearing surfaces of hub and pin are arranged such that they restrict bidirectional relative rotation of the hub and the pin about the remaining two axes as well as restricting bidirectional relative linear motion of the hub and pin along two axes but only restricting unidirectionally relative linear motion of the hub and pin along the shared axis of rotation.

This is achieved via bearing surface(s) created between hub and body that are non-parallel to the hub and pin shared axis of rotation, capable of restricting the motions listed.

The bearing surfaces of hub and pin may be arranged such that they restrict bidirectional relative rotation of the hub and the pin about the remaining two axes as well as restricting bidirectional relative linear motion of the hub and pin along two axes yet does not restrict in either direction relative linear motion of hub and pin along the shared axis of rotation.

The hub bearing system may further comprise at least one axially-extruded (along the hub and pin shared axis of rotation) void within the hub void of revolution opening, creating at least one thrust face within the hub. This thrust face may have an additional bearing material fixed to it.

The hub bearing system may further comprise the at least one axially-extruded (along the hub and pin shared axis of rotation) solid attached to the pin, creating at least one thrust face attached to the pin. This thrust face may have an additional bearing material fixed to it.

The hub bearing system may further comprise at least one axially-extruded (along the hub and pin shared axis of rotation) void within the hub void of revolution opening, creating at least one thrust face within the hub. This thrust face may have an additional bearing material fixed to it. The hub bearing system may further comprise at least one axially-extruded (along the hub and pin shared axis of rotation) solid attached to the pin, creating at least one thrust face attached to the pin. This thrust face may have an additional bearing material fixed to it.

Relative linear motion of hub and pin along the shared axis of rotation of hub and pin may be restricted by the contact of hub and pin thrust faces in one direction.

Relative linear motion of hub and pin along the shared axis of rotation of hub and pin may also be restricted by the contact of hub and pin thrust faces in the opposite direction.

An independent thrust washer may be accommodated in-between the hub and pin thrust faces, yet may be free to rotate relatively independently of both hub and pin.

Either hub or pin thrust faces may have additional bearing material fixed to them.

The hub bearing system may further comprise at least one axially extruded (along the shared hub and pin axis of rotation) groove within the hub void of revolution opening, and the at least one thrust washer, wherein the at least one thrust washer is axially accommodated within the at least one axially-extruded groove. The thrust washer can be one of: (i) held so it rotates with the hub, relative to the pin (or an integral part of the hub); (ii) held so it rotates with the pin, relative to the hub (or an integral part of the pin; or (iii) merely accommodated between both hub and pin relative rotating surfaces

The hub bearing system my further comprise a first thrust body positioned axially along the solid of revolution pin (or connected to an end face of the pin) and a surface of the at least one thrust washer, restricting relative linear motion of hub and pin along the shared axis of relative rotation of hub and pin.

The hub bearing system may further comprise a second thrust body positioned axially along the solid of revolution pin (or connected to an end face of the pin or connected to the end face of the first thrust body) and an opposite surface (relative to the thrust washer surface above) of the at least one thrust washer, restricting relative linear motion of hub and pin along the shared axis of relative rotation of hub and pin, in the direction opposite.

The hub bearing system may further comprise a non-turn pin extending from a position in the solid of revolution pin and through first thrust body (if the first thrust body is connected to an end face of the pin) and through the second thrust body (if the second thrust body is connected to either an end face of the pin or an end face of the first thrust body). This is to ensure that pin and both thrust bodies are rotationally fixed relative to each other.

The non-turn pin does not pass through the thrust washer.

The hub bearing system may further comprise a bolt and washer for securing the first and/or second thrust bodies to the solid of revolution pin (where either or both thrust bodies are connected to an end face of the pin or the other thrust body).

The hub and thrust washer may rotate relative to the pin, and the pin may be fixed.

The pin may rotate relative to the hub and thrust washer, and the hub and thrust washer may be fixed.

The hub may be fixed to a supporting frame. The hub may be fixed to a rotatable element.

The solid of revolution pin may be connected to a rotatable element. The solid of revolution pin may be fixed to a supporting frame.

A second axial end of the solid of revolution pin (or an axial end of either thrust body) may be provided with a screw thread which is fitted to the rotatable element.

A second axial end of the solid of revolution pin (or an axial end of either thrust body) may be provided with a screw thread which is fitted to a supporting frame.

There is provided agricultural machinery comprising: a supporting frame; a housing (hub) comprising a void of revolution, the housing being fixably attached to the supporting frame; a solid of revolution bearing accommodated within the void of revolution of the housing; and a solid of revolution pin accommodated within the solid of revolution bearing, and having one end fixably attached to a rotatable element.

There is provided agricultural machinery comprising: a supporting frame; a rotatable element; a housing (hub) comprising a void of revolution, the housing being fixably attached to the rotatable element; a solid of revolution bearing accommodated within the void of revolution of the housing; and a solid of revolution pin accommodated within the solid of revolution bearing, and having one end fixably attached to the supporting frame.

There is provided agricultural machinery comprising a thrust washer accommodated within the solid of revolution bearing, fixably attached to another end of the solid of revolution pin.

### BRIEF DESCRIPTION OF THE DRAWINGS

The invention is described by way of example to the accompanying drawings in which:

FIG. 1 illustrates a basic solid of revolution pin;

FIG. 2 illustrates the introduction of a non-turn pin to the basic solid of revolution pin;

FIGS. 3(a) and 3(b) illustrate the fitting of the basic pin within a hub (housing), including the fitting of a plain solid of revolution bearing within the hub;

FIG. 4 illustrates the addition of a first thrust body to the basic pin within the hub;

FIG. 5 illustrates a view of the basic pin with the non-turn pin and the first thrust body;

FIGS. 6(a) and 6(b) illustrate the arrangement of FIG. 4 with the fitting of a thrust washer to the basic pin with the first thrust body within the hub;

FIG. 7 illustrates the arrangement of FIG. 6 without the hub and journal bearing and shows the positioning of the thrust washer relative to the first thrust body;

FIG. 8 illustrates an alternate view of FIG. 6 showing the positioning of the thrust washer slotted into a recess within the hub and the anti-rotation lugs of the thrust washer in the cavities of the hub;

FIG. 9 illustrates the arrangement of FIG. 6 and the fitting of a second thrust body to the basic pin within the hub;

FIG. 10 illustrates the fitting of a retaining bolt and washer to the basic pin within the hub;

FIGS. 11(a) and 11(b) illustrate schematics of the exemplary hub bearing system;

FIG. 12 illustrates the inclusion of an annular ring in the hub and basic pin assembly;

FIG. 13 illustrates a perspective view of the assembly showing more detail of the basic pin;

FIG. 14 illustrates a non-cutaway view of FIG. 12;

FIG. 15 illustrates a further alternative perspective view of the assembly of FIG. 14;

FIG. 16 illustrates two flanged bush journal bearings for use in a hub bearing system;

FIG. 17 illustrates the flanged journal bearings with a basic pin within them, and also shown are flanged journal bearing non-rotation pins;

FIG. 18 is the arrangement of FIG. 17 plus a thrust washer fitted to a basic pin;

FIG. 19 illustrates the arrangement of FIG. 18 fitted within a hub; and

FIG. 20 illustrates a part cut-away view of FIG. 19.

### DESCRIPTION OF PREFERRED EMBODIMENTS

The invention is now described with reference to examples and embodiments.

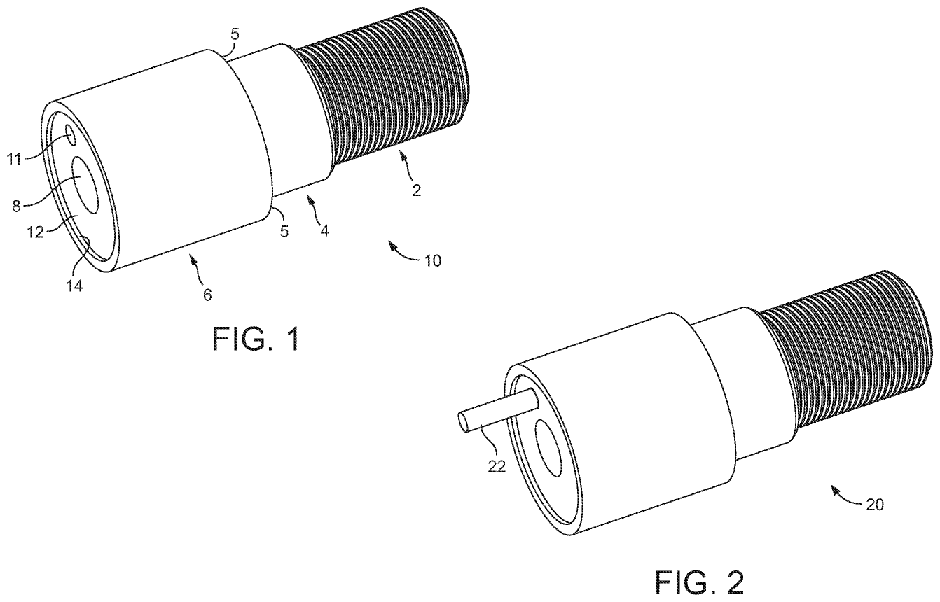

With reference to FIG. 1 there is illustrated a perspective view of an exemplary basic pin 10 of a hub bearing system, with reference to which a first embodiment will be described.

The basic pin 10 is preferably a basic solid of revolution. The exemplary basic pin 10 comprises a cylindrical element having three distinct portions of different outer diameters. A first portion 2 having the smallest outer diameter is screw threaded. A second portion 4 has a middle outer diameter and a third portion 6 has the largest outer diameter. The portions 2 and 6 of the exemplary basic pin 10 are disposed at either end of the cylindrical pin, and the portion 4 in the middle, effectively joining the portions 2 and 6. The radial steps between the portions 4 and 6 and the portions 4 and 2 create a non-parallel (to the axis of rotation) radial surface along the pin. The radial step between the portions 4 and 6 is denoted by reference numeral 5.

The portion 6 has a radial end face 12, having an opening 8 for a hollow axial portion, which as will be described further below accommodates a retaining element. The face 12 is also provided with an off-centre or off-rotation axis hollow portion or recess 11 for a non-turn pin to be accommodated, as described further hereinbelow. The face 12 may contain a recess or a protrusion relative to the external surface of the portion 6 to aid alignment of components fitted later.

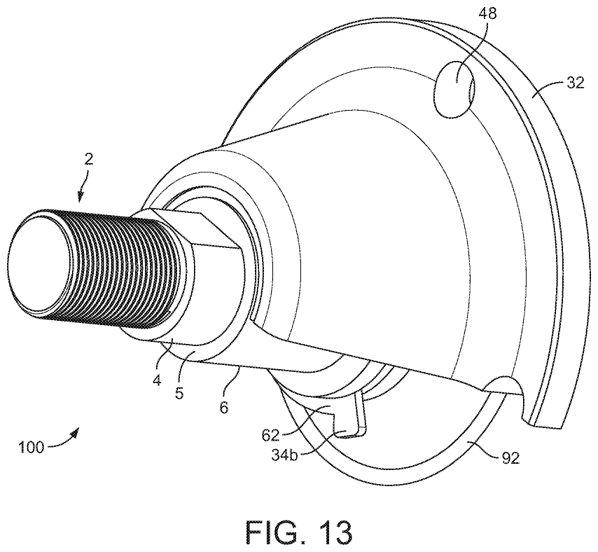

Also identified in FIG. 1 is a surface denoted by reference numeral 5, which denotes a step-down shoulder surface between portions 6 and 4 (and which is further illustrated in FIG. 13 later).

For assembly of the bearing, the basic pin 10 as shown in FIG. 1 may be prevented from turning by fitting it into a jig.

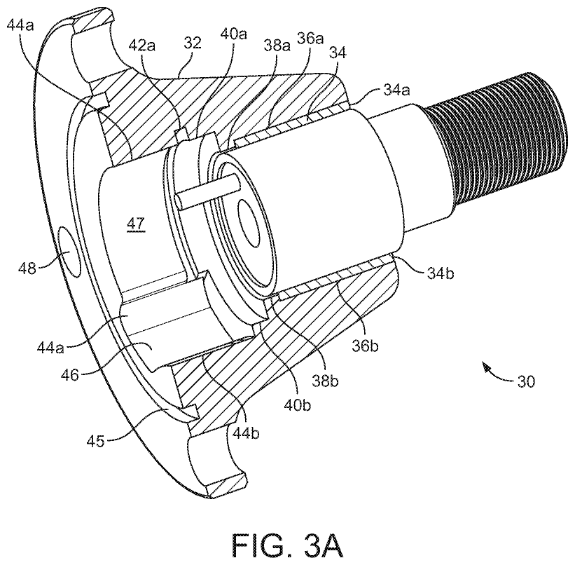

With reference to FIG. 2, there is shown the addition of the non-turn pin 22. This pin is accommodated within the off-rotation-axis void 11 within the basic pin 10, in this case shown being positioned with its axis parallel to the rotational axis of the basic pin 10. The pin will be accommodated within a certain depth of the recess 11, and then protrude externally from the surface 12 as shown in FIG. 2.

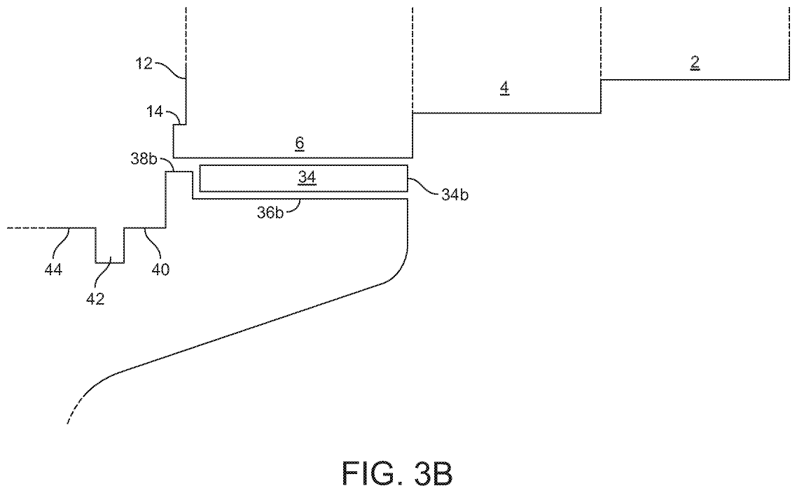

As shown in FIGS. 3(a) and 3(b), the plain basic pin 10 with the non-turn pin 22 may be fitted into a hub or housing, the overall assembly being denoted by reference numeral 30.

In FIG. 3 there are shown three elements: the basic pin 10 of FIG. 1, a hub or housing as denoted by reference numeral 32, and a plain bearing denoted by reference numeral 34.

The hub or housing 32 is exemplary, and other hubs or housings having different dimensions and configurations may be provided.

FIG. 3(a) shows a cut-away of the hub 32 to allow illustration of the installation of the basic pin 10 in the hub. It will be understood that the hub completely encompasses portion 6 of the basic pin 10 in the final construction, as will be shown further hereinbelow. The hub 32 of FIG. 3(a) represents half of a complete hub.

FIG. 3(b) shows a cross-section through the cut-away of FIG. 3(a), to assist in illustrating the positioning of elements of the system.

The hub 32 preferably comprises a solid of revolution with a void of revolution formed therein. The hub 32 is hollowed out and generally can be considered as containing a cavity or void. The void of the hub 32 has a first portion which is shaped to accommodate the basic pin 10 of FIG. 1, and as can be seen in FIG. 3(a) this hub has a first void section having an axial surface 38 denoted by reference numerals 38a, 38b forming an approximate dimension to house the circumference of the first portion 6 of the basic pin 10. The end of the basic pin 10 having the face 12 is accommodated in this section.

The void of the hub 32 also extends to cover any remaining part of portion 6 of the basic pin 10, but with this portion of the void in the hub 32 having a larger outer diameter such that there is an additional gap between the outer diameter of portion 6 of the basic pin 10, and an inner surface 38c of the void within the hub. This difference in outer diameters creates a radial gap in the hub void, between the outer surface of section 6 of the pin and the inner surface 36a, 36b of the hub.

Within this additional gap is provided the plain bearing 34, the edges of which are shown in FIG. 3(a) by reference numerals 34a and 34b. The plain bearing 34 is thus fitted between the inner surface 36 denoted by reference numerals 36a, 36b of the void within the hub 32, and the outer diameter surface of at least part of the portion 6 of the basic pin 10.

As can be seen from FIG. 3(a), the portions 4 and 2 of the basic pin 10 protrude from the hub 32, and in this example are not encased within the hub.

As is also seen in FIG. 3(a) the portion of the hub void which is adjacent to the surface 12 of the basic pin 10 has a further section of a greater internal diameter opening than the surface denoted by reference numeral 38a. This surface is denoted by reference numeral 40.

Next to this surface there is provided a first axial extrusion or groove 42 within the hub, which has a surface denoted by reference numeral 42a. This axial extrusion is thus preferably formed within the void of revolution of the hub 32. This axial extrusion exists to accommodate a thrust washer, the purpose of which will be discussed hereinafter.

FIG. 3(a) also shows that a second axial extrusion is formed (denoted by axial surfaces 44a, 44b and 46) within the void of the hub. This axial extrusion allows for the fitting and accommodation of the thrust washer, and anti-rotation lugs for the thrust washer, as will be discussed hereinbelow.

There is also adjacent to the second axial extrusion 42 a further inner surface 47 of the void within the hub. As shown in FIG. 3(a) this axial surface 47 is not continuous, and opens out into a larger void as denoted by reference numeral 46, which is the second axial extrusion. The portion 46 has edges 44a and 44b which extend from the radial surface 47 to a larger radial opening.

The first axial extrusion 42 extends to open within this second axial extrusion 46.

The exemplary hub 32 has a generally conical external shape, having a narrowest outer diameter at the point at which the portions 4 and 2 of the pin 10 extend from the hub, and having a largest outer diameter at the portion which encompasses the inner surface 47. This external diameter is sufficiently large to encompass axial extrusions or openings such as axial extrusion 48, which can be used for fitting the hub 32 to a piece of machinery in an implementation (or to a relative rotating external component).

As also shown in FIG. 3(a) the hub 32 is provided with a further groove or void of revolution 45 within the end face of the hub, the purpose of which will be discussed further hereinbelow.

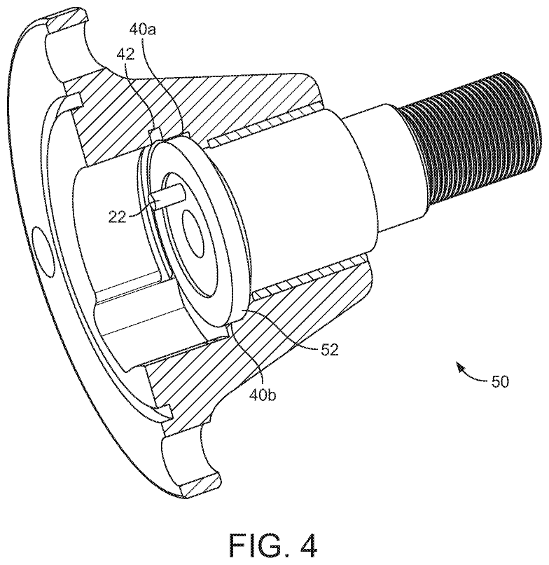

Turning to FIG. 4, there is shown the addition of a first thrust body element denoted by reference numeral 52, in the inner axial surface of the hub void denoted by reference numeral 40a, 40b. Note there is preferably a non-rotation hole through the body 52 that fits over the non-turn pin 22, ensuring the thrust body 52 rotates with pin 10. The purpose of this first thrust body is to restrict the relative linear motion of the basic pin 10 relative to the hub 32—in one direction of the pin axis, via the contact of the radial face of the thrust body 52 against the thrust washer which is axially located in axial extrusion 42 as described hereinbelow.

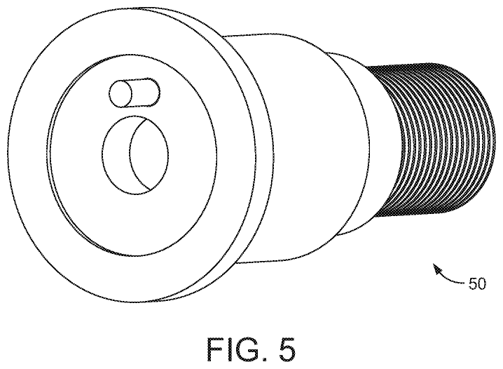

FIG. 5 illustrates an alternative perspective view of the basic pin 10 with the non-turn pin 22 and the first thrust body element added to it, but without the hub 32 and plain bearing 34 shown, denoted as assembly 50.

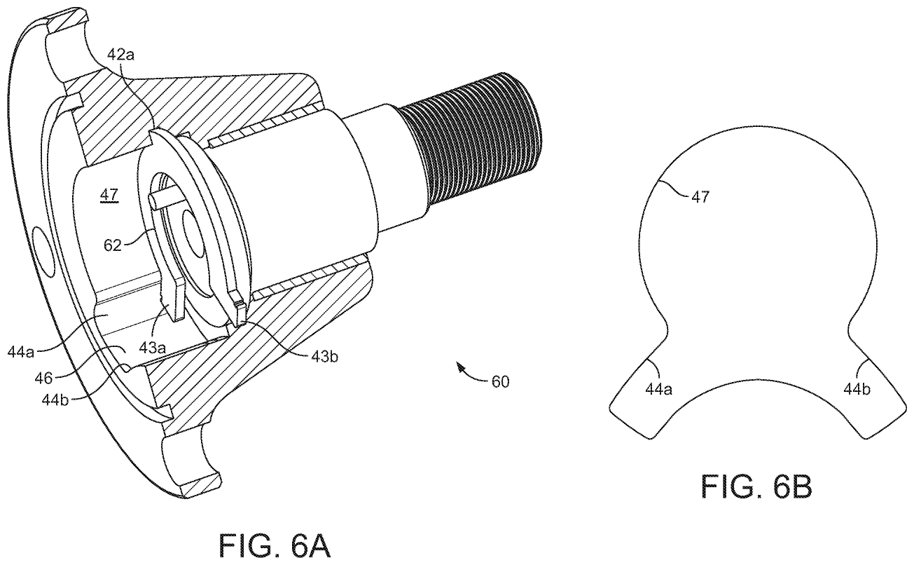

FIG. 6(a) shows the addition of an exemplary thrust washer 62 which is axially restricted within the axial extrusion (or groove) 42.

To achieve this axial restriction within axial extrusion 42 requires the thrust washer to axially traverse within the axial void bounded by axial surfaces 47, 44a, 46 and 44b, and then once axially adjacent axial extrusion 42 to radially move so that the further axial linear motion of the thrust washer relative to the hub is restricted by the radial surfaces of the axial extrusion 42. Note there has to be radial clearance between thrust washer and the axial surfaces 44a, 46 and 44b to allow this axial travel from hub end face to axial extrusion 42.

The thrust washer 42 has two anti-rotation lugs, or retaining portions, 43a and 43b. The exemplary thrust washer shown is not a 360° solid of revolution body generated by revolution about the axis of rotation, such that it is not an entire annular ring. The thrust washer 62 does not complete an annular ring, but terminates at the anti-rotation lugs 43a and 43b. These anti-rotation lugs extend into the axial extrusion bounded by axial surfaces 44a, 46 and 46b when the thrust washer is in situ, in order to restrict the relative angular motion of the thrust washer 62 relative to the hub 32, each lug restricting relative angular motion in one direction. Alternative designs may be provided in order to retain the thrust washer in place. The thrust washer does not have to be formed in the specific arrangement as shown, nor does the housing 32 have to be formed to have the specific arrangement to accommodate this specifically shaped thrust washer.

FIG. 6(b) illustrates in plan view the opening into which the thrust washer 62 is positioned.

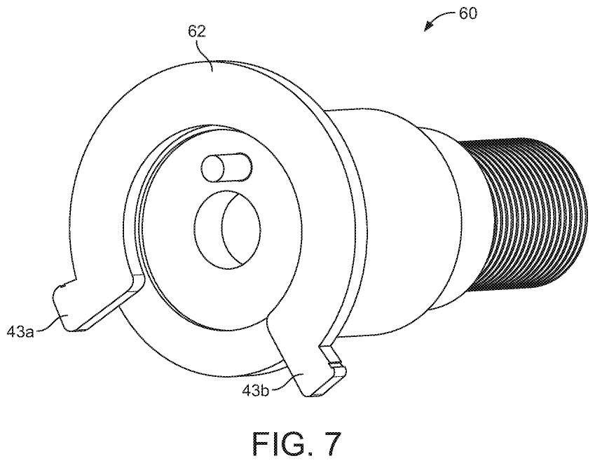

With reference to FIG. 7, there is illustrated the assembly 50 of FIG. 5 with the thrust washer 62 added to it, without the housing 32 and plain bearing 34 illustrated for ease of reference. This shows the anti-rotation lugs 43a and 43b of the thrust washer 62, and also the radial alignment of the thrust washer radial bearing surface against the radial thrust face of the first thrust body element 52. This assembly shown in FIG. 7 is denoted 60.

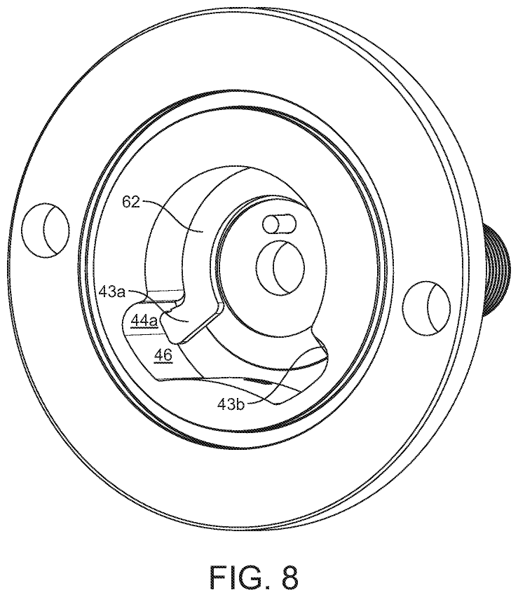

With reference to FIG. 8, there is shown a close-up view of the arrangement of FIG. 6 from a different perspective, showing the thrust washer 62 and one of the anti-rotation lugs 43a, accommodated within the void bounded by the axial surfaces 44a and 46.

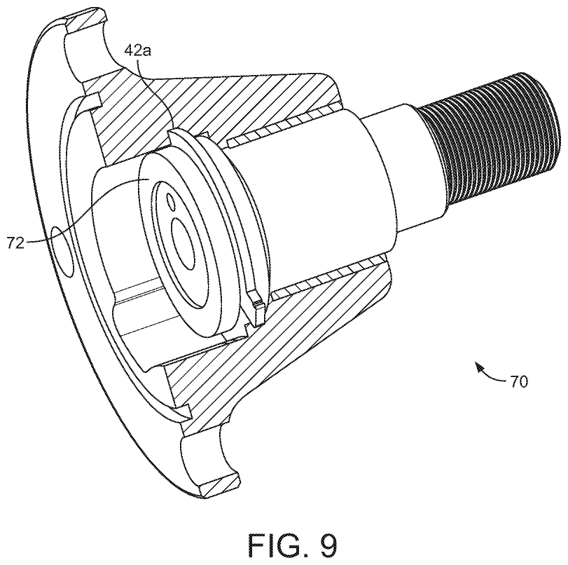

Turning to FIG. 9, there is illustrated the addition of a second thrust body element 72 to the arrangement of FIG. 6. This second thrust body element 72 is accommodated within the axial surface 47 of the void of revolution within housing 32, and adjacent to the thrust washer 62.

This second thrust body element 72 operates to restrict the relative linear motion of the pin and hub in the opposite direction to that of the first thrust body element 52.

Hence via two thrust body elements and one thrust washer, axial relative motion of the hub 32 and the basic pin 5 is restricted.

It should be noted that both thrust body elements are provided with a radially off-set axial extrusion to accommodate the non-turn pin 22, which extends at least partly through the second thrust body element and fully through the first thrust body element, to ensure that both thrust body elements and the pin rotate together.

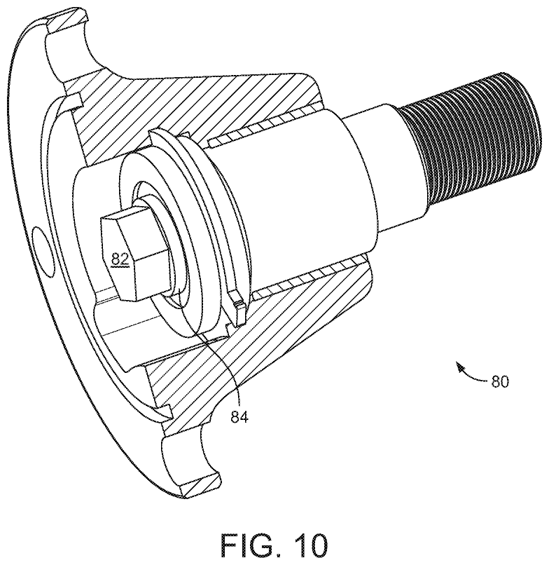

With regard to FIG. 10 there is illustrated the addition of a retaining element to the arrangement of FIG. 9. This addition to the basic pin 10, non-turn pin 22, first thrust body element 52 and second thrust body element 72 is denoted by reference numeral 80.

A hexagonal head bolt (and a washer) is added to the arrangement. The hexagonal head bolt is represented by reference numeral 82, and the washer is represented by reference numeral 84. The axial void 8 within the basic pin 10 is preferably provided with a screw thread along at least a portion of its axial surface, and the hexagonal head bolt 82 is screwed into this screw thread, so as to secure the first 52 and second 72 thrust body elements to the basic pin 10, and enclose the non-turn pin 22 which ensures that the assembly 80 rotates together.

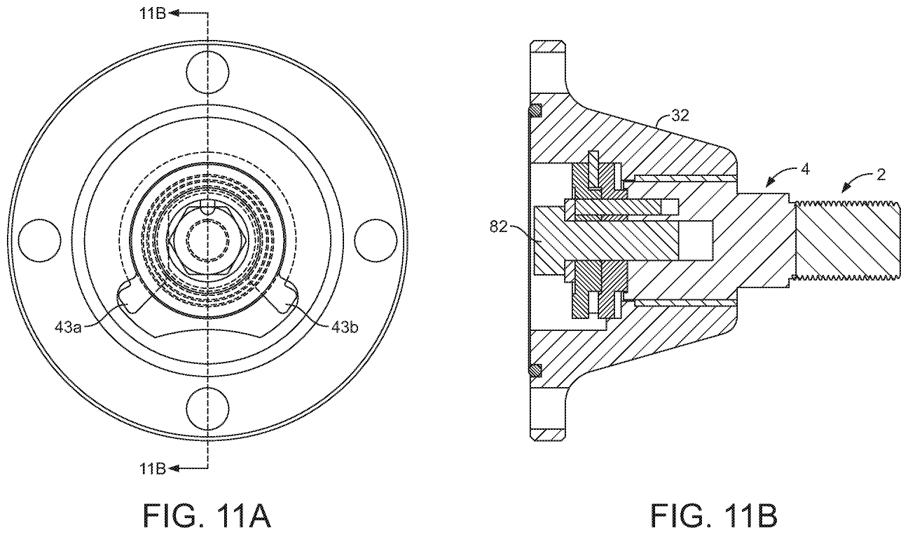

FIGS. 11(a) and 11(b) show plan and sectional drawings of the complete hub bearing system as described, with the addition of an O-ring within the void 45 in the end face of the hub 32.

FIG. 11(a) shows a plan view of the complete system looking towards the hexagonal head of bolt 82, and then FIG. 11(b) shows a cross-section through the system.

Referring to FIG. 11(a) the two anti-rotation lugs 43a and 43b of the thrust washer can be seen, and referring to FIG. 11(b) the hexagonal head bolt 82 can be seen extending into the void 8 which, in this instance, is shown extending only into portion 6 of the basic pin 10—but this could extend into both portions 4 and 2.

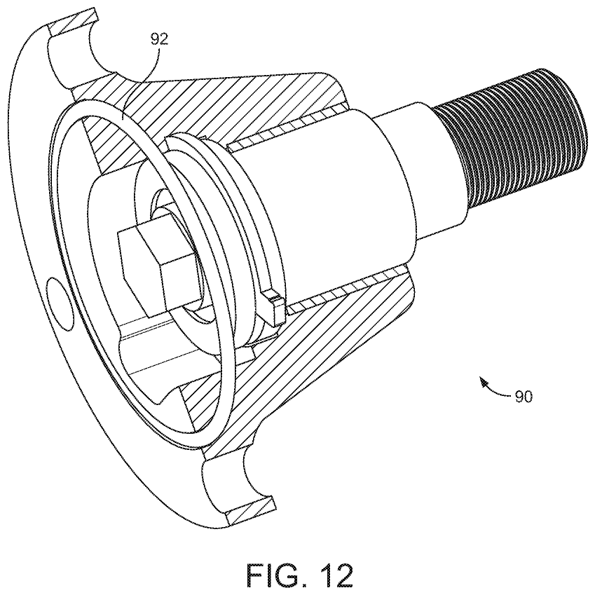

FIG. 12 shows the arrangement of FIG. 10 with the addition of an annular ring 92 within the void 45. When the hub 32 is fitted to another piece of machinery (or a piece of rotating equipment) using fixings through axial extrusions such as axial extrusion 48, then the ring 92 may be used to provide a seal with such fitting.

With regard to FIG. 13, a different perspective view of the arrangement of FIG. 12 is illustrated, from the reverse view of FIG. 12 showing portions 2, 4 and 6 of the basic pin 10. One of the anti-rotation lugs 43 of the thrust washer 62 can be seen, and also a portion of the ring 92 can be seen. Also shown in FIG. 13 is a flat axial extrusion section of portion 4 of the pin 10—denoted by reference numeral 4a. This is utilised as an anti-rotation feature when pin 10 is slid into a fitting aperture (that has a corresponding anti-rotation feature) of an external component.

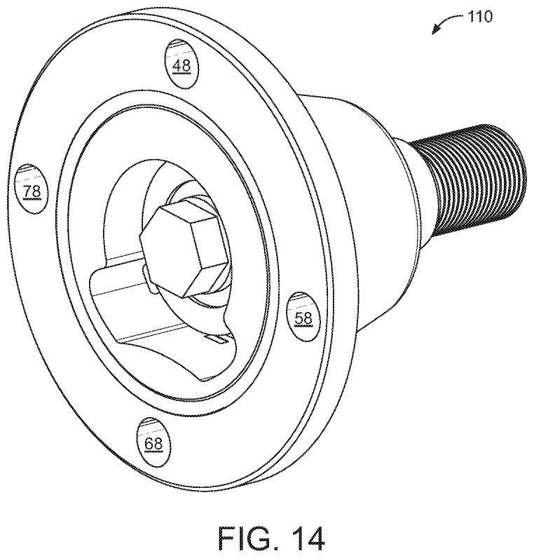

With reference to FIG. 14 a close-up (non-cut-away) view 110 is shown of the complete hub bearing system, i.e. hub 32 and the plain bearing 34 are not shown in section. As shown in FIG. 14 the hub is provided with four axial extrusions 48, 58, and 78, which can be used to fix the hub to an external component.

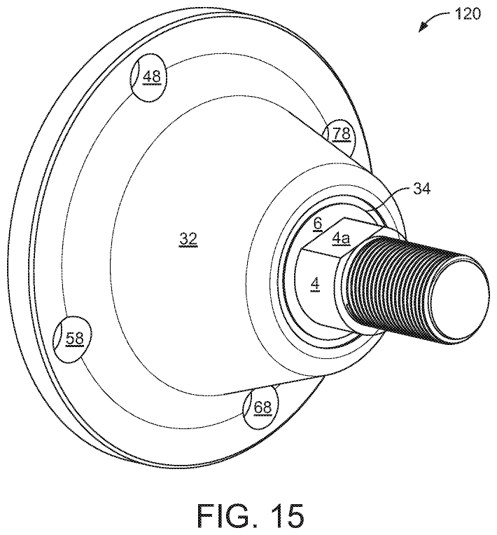

FIG. 15 shows a different perspective view, from the opposite direction of FIG. 14, which shows the hub 32 with the axial extrusions 48, 58, 68 and 78, and the portions 6, 4 and 2 of the basic pin 10, with portions 4 and 2 shown protruding from the void of revolution within hub 32. As also can be seen in FIG. 15 is the plain bearing 34 extending radially around the outer diameter surface of portion 6 of the pin 10.

As can also be seen in FIG. 15 the portion 4 may not be entirely a solid of a full revolution about the axis of rotation, and may have a flat surface (formed via an axial void extrusion) as denoted by reference numeral 4a along a portion of portion 4.

With this first embodiment there has been shown a cylindrical journal bearing which allows bidirectional relative rotation of the hub and pin about their shared axis of rotation. This bearing is also capable of restricting relative rotation about the other two perpendicular axes due to its finite length. Relative linear motion is also restricted about the two axes perpendicular to the shared axis of rotation of hub and pin. However relative linear motion of the hub and pin is not restricted by this bearing. Hence the use of the thrust washer axially restricting bidirectional relative linear motion of hub and pin along the shared axis of rotation. This may be direct contact of thrust-faces on hub and pin, or the use as shown in the exemplary first embodiment of an intermediary sliding element.

There is now described alternate second embodiment of a hub bearing system. This second embodiment utilises the same principles as the described first embodiment. These principles are:
1. At least one void/opening within a hub body, the void/opening preferably being a revolution opening; and
2. At least one bearing accommodated within the hub body, preferably a solid bearing, preferably being a solid of revolution bearing.

If the void of revolution opening(s) and solid of revolution bearing(s) do not restrict relative axial linear motion of the hub and the pin (as well as restricting all the other previously listed relative motion restrictions required), then additional bearing(s) are introduced to perform this/these restriction(s) where necessary.

The second embodiment is a modification of the first embodiment, in as much as:
1. The single cylindrical bearing of the first embodiment is replaced with two cylindrical bearing components in the second embodiment; and
2. The first embodiment restricts the axial relative linear motion of the pin and the hub in one direction via the use of a thrust-face on the first thrust-body in contact with a thrust-face on one side of a thrust washer, and restriction in the other direction is achieved via the use of a thrust-face on the other side of the same thrust washer in contact with a thrust-face on the second thrust body.

The second embodiment achieves the same result, but utilises two thrust washers, each of which is connected to one of the cylindrical bearings in opposed directions). Two thrust body thrust-faces are again employed. One thrust body thrust-face is an integral part of the pin, the other thrust body thrust-face is a washer that axially slides onto the pin to create the second thrust-face, resulting in the required relative linear motion restriction which is not facilitated by the use of cylindrical bearings alone.

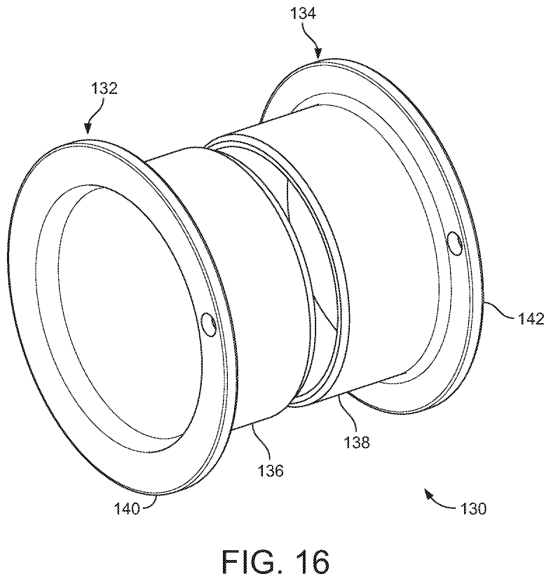

There is shown in FIG. 16 two flanged bush elements 132 and 134, which in this arrangement are provided on the basic pin of FIG. 3 as the plain bearing.

Bush 132 is a hollow cylindrical portion having an outer surface 136, and an extended lip 140 at one end. Bush 134 is also a hollow cylinder having an outer surface 138, and an extended lip 142 at one end.

FIG. 16 thus shows two exemplary plain bearings according to the second embodiment, which are denoted by reference numerals 132 and 134. Plain bearings 132 and 134 each preferably comprise solid of revolution plain axial portion bearings 136 and 138 respectively (in this instance shown as cylindrical), and solid of revolution plain radial portion bearings 140 and 142 respectively (in this instance shown as perpendicular to the pin-rotation-axis).

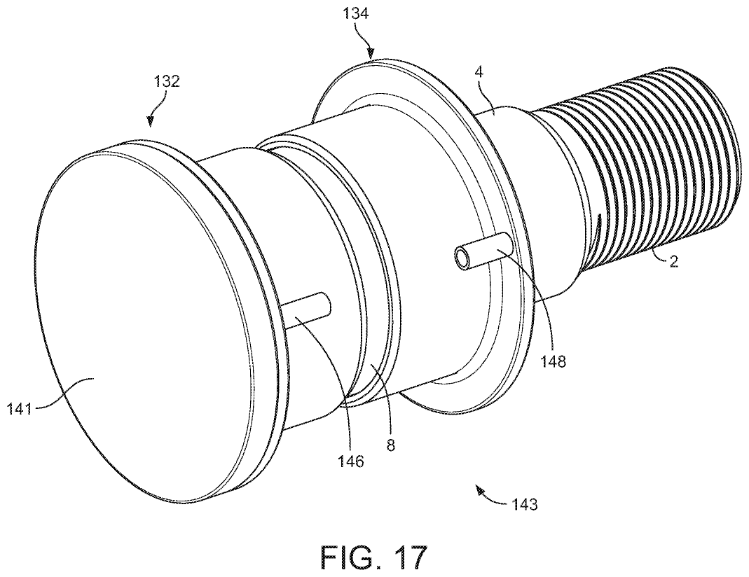

With reference to FIG. 17, the bush elements 132 and 134 are fitted onto the surface of the first portion 6 of the basic pin 10. The bush elements 132 and 134 are fitted to the first portion 6 such that the lip 142 of one element is positioned at one edge of the portion 6, and the lip 140 is positioned at the other edge of the portion 6.

As shown in FIG. 17, there is provided a cap 142 which is fitted over the end of the basic pin around the lip 140, once the bush element 132 is fitted. The non-turn pin 146 extends through an opening in the lip portion 146, into a protrusion in the cap 142.

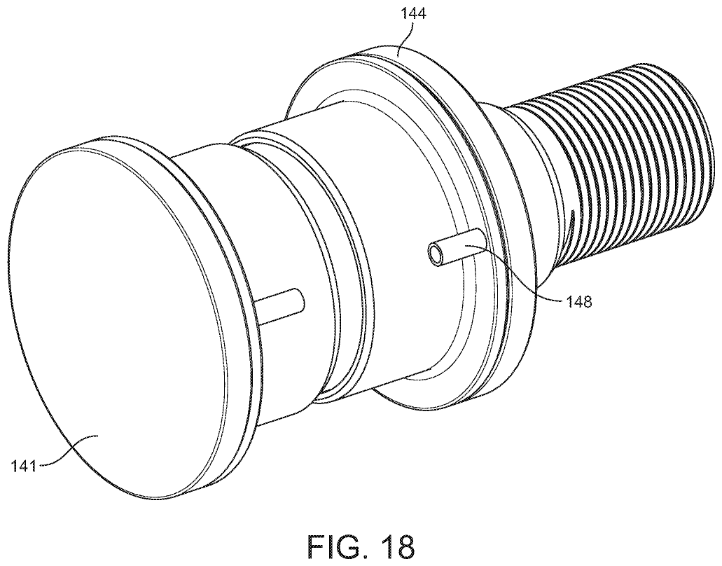

FIG. 17 also shows a non-turn portion 148 extending into an opening in the lip 142 of the bush element 134. In FIG. 18 there is shown a further cap 144 which is fitted to the bush element 134. This further cap is fitted against the lip 142, and the non-turn pin 148 extends through the opening in the lip 142 into a retaining portion formed in the cap 144.

FIG. 17 thus shows a pin similar to pin 10 of the first embodiment (with portions 2, 4 and 6) but in this second embodiment the second thrust body of the first embodiment is now an integral part, denoted 141, of pin 10.

Also shown in FIG. 17 are solid of revolution plain bearing anti-rotation pins 146 and 148. These are utilised so that the bearings rotate with the hub 32—as in this instance the bearings become an integral part of the hub—as shown later.

As shown in FIG. 17, there is provided a cap 142 which is fitted over the end of the basic pin around the lip 140, once the bush element 132 is fitted. The non-turn pin 146 extends through an opening in the lip portion 146, into a protrusion in the cap 142.

FIG. 17 also shows a non-turn portion 148 extending into an opening in the lip 142 of the bush element 134. In FIG. 18 there is shown a further cap 144 which is fitted to the bush element 134. This further cap is fitted against the lip 142, and the non-turn pin 148 extends through the opening in the lip 142 into a retaining portion formed in the cap 144.

FIG. 18 shows the addition of the first thrust body. In the second embodiment the first thrust body is a ‘washer’ that is installed over portion 4 of the pin 10, portion 6 being the portion within bearings 132 and 134. There is a ‘step’ on the pin 10 that the first thrust body locates against, fixing the axial distance of the first thrust body from the second thrust body. The assembly of the pin 10 (comprising second thrust body 141, pin portions 2, 4 and 6) and first thrust body 144 is denoted by reference numeral 150.

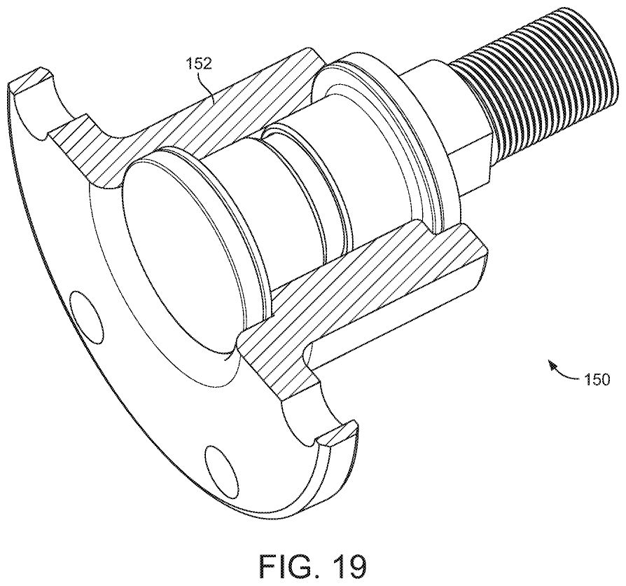

With reference to FIG. 19, there is shown the assembly of FIG. 18 mounted in a housing element 150, the housing element being denoted by reference numeral 152. The housing element has an internal hollow opening, having a radius which accommodates the portion 6 of the basic pin 10 with the bush elements 132 and 134 fitted. As can be seen in FIG. 19, the internal radial opening of the housing element has a dimension to accommodate the bush elements 132 and 134, and then at the end of the portion 6 this radial dimension increases to accommodate the caps 142 and 144. Thus the pin is retained in position by the shape of the internal housing element 152.

FIG. 19 shows how bearings 132 and 134 are fitted within the void of the hub (preferably a void of revolution), and the resulting positioning of the assembly within these bearings as denoted by reference numeral 150.

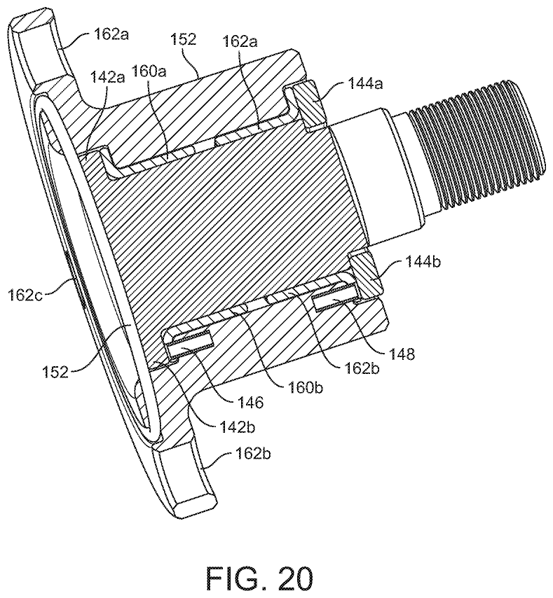

With reference to FIG. 20 there is shown a part-cut-away view of the complete hub bearing system of the second embodiment.

FIG. 20 shows an illustration similar to FIG. 19, but eliminating some of the detail of the housing pin and in particular the portion 2, so as to illustrate its structure.

As shown in FIG. 20, the caps 142 and 144 are provided at either end of the portion 2 of the pin, there being sharing portions 142a and 142b representing the pin 142, and portions 144a and 144b representing the cap 144.

The two non-turn pins 146 and 148 are shown. These are shown as extending from the relative caps 142 and 144, through the extended lip of the relevant bush elements and into the body of the housing element 152. Reference numerals 160a, 160b represent portions of the bush element 132, being both the extended lip 140 and the outer portion 136. Reference numerals 162a, 162b represent portions of the bush element 134, being both the extended lip 142 and portions 138.

Also shown in FIG. 20 is an annular ring 152 which serves the purpose of providing a seal when the housing 152 is fitted to an additional piece of machinery.

As shown in the cut-away of FIG. 20, there are openings 162a and 162b in the housing 152 which allow retaining elements to pass through to fit the housing 152 to a piece of machinery, and opening 162c is also provided for this purpose.

The housing 152 of FIG. 20, or the housing 32 of FIG. 15 (for example) may be fitted to a further piece of machinery using the fittings. An example implementation is that the portion 2 of the basic pin is fitted to a piece of agricultural machinery, such as plough machinery. A plough disk is then fitted to the housing element (hub). The basic pin 10, including all portions 6, 4 and 2, then remains stationary and fixed, with the housing element itself rotating with the disk. Thus portion 6 remains stationary whilst the housing (and its' included bearing(s) and effective thrust washer(s) rotates relative to portion 6 (for example in Design 1 both bearing 34 and thrust washer 62, or for Design 2 bearings 132 and 134).

The second embodiment illustrates a variation of the first embodiment, where cylindrical journal bearings are employed as in the first embodiment, but the ‘thrust washer’ principle is replaced via two ‘flange’ bearing elements (shown as an integral additional parts of the cylindrical journal bearings in the illustrated second embodiment), bi-directionally restricting the relative linear motion of hub and pin via thrust faces on hub and pin—these thrust faces are non-parallel to the shared axis of rotation of hub and pin, enabling this relative linear motion restriction.

The invention has been described with reference to particular examples, features of which may be combined. Not all described features are essential.

1. A hub bearing assembly comprising:
a housing having an internal cylindrical opening;
an annular bearing accommodated within the cylindrical opening of the housing; and
a cylindrical pin accommodated within the annular bearing,
wherein the housing and the cylindrical pin rotate relative to each other.

2. The hub bearing assembly of claim 1 wherein the housing has an annular groove within the cylindrical opening, and further comprising a thrust washer accommodated within the annular groove.

3. The hub bearing assembly of claim 1 wherein the annular bearing is fixed so that it rotates with the hub relative to the pin or so that it rotates with the pin relative to the hub.

4. The hub bearing assembly of claim 1 wherein the annular bearing is accommodated between the housing and the cylindrical pin as an independent body.

5. The hub bearing assembly of claim 1 wherein the housing and the cylindrical pin rotate in the same direction or in opposite directions.

6. The hub bearing assembly of claim 1 configured to minimise relative rotation between the housing and the cylindrical pin about the two axes perpendicular to their common axis of rotation.

7. The hub bearing assembly of claim 6 wherein the annular bearing has a finite length in the direction of the common axis of rotation.

8. The hub bearing assembly of claim 1 configured to minimise relative linear motion of the housing and the cylindrical pin along the common axis of rotation.

9. The hub bearing assembly of claim 1 configured to minimise relative linear motion of the housing and the cylindrical pin along the two axes perpendicular to their common axis of rotation.

10. The hub bearing assembly of claim 9 configured to minimise the linear motion of the housing and the cylindrical pin along the two axes perpendicular to their common axis of rotation bidirectionally and minimise the linear motion of the housing and the cylindrical pin along the common axis of rotation unidirectionally.

11. The hub bearing assembly of claim 8 wherein the relative linear motion along any of the common axis of rotation or the two axes perpendicular thereto is minimised by providing a bearing surface which is non-parallel to the shared axis of rotation.

12. The hub bearing assembly of claim 1 further comprising a thrust element located adjacent the cylindrical pin, and having a thrust face towards the cylindrical pin.

13. The hub bearing assembly of claim 12 wherein the thrust element is a washer, and further comprising a groove within the inner surface of the cylindrical opening, wherein the thrust washer is accommodated within the groove.

14. The hub bearing assembly of claim 12 further comprising a first disc positioned between a first surface at the first end of the cylindrical steel pin and a surface of the thrust washer and a second disc positioned at the other surface of the thrust washer.

15. The hub bearing assembly of claim 12 wherein the thrust element is one of: fixed so it rotates with the housing relative to the cylindrical pin; fixed so it rotates with the cylindrical pin relative to the housing; accommodated between the housing and cylindrical pin relative rotating surfaces.

16. The hub bearing assembly of claim 1 wherein the annular bearing comprises:
a first annular bearing part between a first part of the cylindrical pin and the internal cylindrical opening of the housing; and
a second annular bearing part between a second part of the cylindrical pin and the internal cylindrical opening of the housing.

17. The hub bearing assembly of claim 16 wherein the first annular bearing part restricts linear motion along the common axis of rotation in a first direction, and the second annular bearing part restricts linear motion along the common axis of rotation in a second direction, the first direction being opposite to the second direction.

18. Agricultural machinery comprising:
a supporting frame;
a housing comprising a cylindrical opening, the housing being fixably attached to the supporting frame;
an annular bearing fitted to the cylindrical opening within the housing; and
a cylindrical steel pin accommodated within the annular bearing, and having one end fixably attached to a rotating element.

19. Agricultural machinery according to claim 18 further comprising a thrust washer accommodated with the annular bearing, fixably attached to an other end the cylindrical steel pin.

20. A fixed rolling element bearing assembly comprising:
a housing;
an inner race for attaching to a rotating shaft;
a cage and rolling element assembly positioned around the inner race;
first and second positional locators for positioning the cage and rolling element assembly between inner edges thereof; and
a thrust washer adjacent an outer edge of either the first or second positional locator and fixably connected to the housing.
